(19) United States
(12) Patent Application Publication
(10) Pub. No.: US 2007/0038361 A1
(43) Pub. Date: Feb. 15, 2007

(54) System and method for improving traffic flow

(76) Inventors: Edward Q. Yavitz, Loves Park, IL (US); John A. Dickey, Rockford, IL (US)

Correspondence Address: VAN SOMEREN, PC, P.O. Box 2107, Cypress, TX, 77410-2107, US

(21) Appl. No.: 11/500,099

(22) Filed: Aug. 7, 2006

Related U.S. Application Data
(60) Provisional application No. 60/706,675, filed on Aug. 10, 2005.

(51) Int. Cl. G08G 1/00

(52) U.S. Cl. 701/117; 340/936

(57) ABSTRACT

A technique facilitates the flow of traffic along highways by placing sensor devices within vehicles traveling along a highway. A sensor device within a first vehicle is able to detect whether the vehicle immediately ahead is increasing or decreasing the distance back to the first vehicle. The driver of the first vehicle is notified of the increasing or decreasing distances through simple indicators that enable the driver to take corrective action more appropriately than otherwise possible. The sensor device and indicators reduce driver overreaction that can result in standing wave traffic patterns, traffic congestion, wasted fuel and wasted time. Additionally, the system can be designed to integrate information from multiple users to enable coordination of movement among motor vehicles to improve overall traffic speed in a given line.

### CROSS-REFERENCE TO RELATED APPLICATION

The present document is based on and claims priority to U.S. provisional application Ser. No. 60/706,675, filed Aug. 10, 2005.

### BACKGROUND

Traffic congestion has been a problem since the day of the chariot. In more modem times, various attempts have been made to relieve traffic congestion. For example, traffic volume control stoplights have been used to provide for timed entry of vehicles onto highways. The stoplights are activated when the density of traffic flow exceeds a certain number of vehicles per hour. Additionally, multiple passenger restricted lanes have been tried as well as reversible “express lanes” to provide more traffic lanes for inbound rush hour vehicles in the morning and outbound vehicles in the afternoon. Despite all of these attempts, traffic congestion has increased dramatically over the past two decades. In the 13 largest US cities, drivers spend the equivalent of eight workdays each year stuck in traffic. According to the US Transportation Department, America loses billions of dollars a year due to freight bottlenecks and delayed deliveries, and consumers lose billions of dollars worth of fuel consumed each year while stuck in traffic jams.

Studies have shown that one of the biggest obstacles to optimal traffic flow is the driver. If drivers were not involved in applying the accelerator and/or the brakes, they would not be able to over react or under react to traffic conditions. The over reactions and under reactions result in “standing wave” traffic patterns and substantial increases in the amount of wasted fuel and general traffic congestion.

When a certain density of traffic is reached, a standing wave or slinky type pattern occurs on the highway even in the absence of any outside conditions such as construction, inclement weather, accidents or police action distractions. The standing wave pattern is characterized by the same number of vehicles per square meter moving at a substantial velocity at one moment and coming to a stop or near stop a few moments later. The traffic expands and contracts because of a human visual defect discovered by the present inventors that renders it impossible for vehicle operators to judge the rate of acceleration or deceleration of the vehicle ahead. A typical scenario occurs when there are enough cars on the highway to prevent easy lane changes. At this point, each driver must react to his or her perception of the speed of the vehicle ahead. Once any driver in a full lane applies the brakes, even if the vehicle is not slowing substantially, a chain of events is initiated that often leads to stopped traffic. The inability of the human visual system to accurately gauge rates of deceleration causes drivers to overcompensate so that each subsequent car in a highway lane slows more than is required until the traffic in that lane has stopped. As the traffic in the lane begins to move again, drivers cannot accurately gauge the rates of acceleration of the cars ahead of them so they do not speed up as fast as they could. Accordingly, the unwinding of the traffic jam is slower than expected as well. Traffic continues to expand slower than it should and to contract faster than it should such that the same number of cars per square meter are moving at a substantial rate one moment and at a stop or near stop a few moments later.

### SUMMARY

In general, the present invention provides a system and a methodology for facilitating the flow of traffic along a highway. The system and methodology enable a vehicle to maintain a more equal speed with the preceding vehicle to create an efficient and smooth flow of traffic. The smoother traffic flow results in improved fuel consumption and reduced emissions. The technique utilizes a sensor system and a simple indicator to aid the driver of a vehicle in determining whether the distance to the preceding car is increasing or decreasing, prompting the driver as to the appropriate time to begin braking or accelerating. The braking may not coincide with the first sign of brake lights showing on the vehicle ahead.

### BRIEF DESCRIPTION OF THE DRAWINGS

Certain embodiments of the invention will hereafter be described with reference to the accompanying drawings, wherein like reference numerals denote like elements, and:

FIG. 1 is a schematic illustration of a system for facilitating smooth traffic flow in a plurality of vehicles moving along a highway, according to an embodiment of the present invention;

FIG. 2 is a schematic illustration of a sensor system and indicator system deployed within a vehicle, according to an embodiment of the present invention;

FIG. 3 is a schematic top view of an embodiment of the sensor and indicator system utilized within a vehicle, according to an embodiment of the present invention;

FIG. 4 is a functional diagram of an energy transmitter and sensor system, according to an embodiment of the present invention;

FIG. 5 is a schematic illustration of another embodiment of the sensor and indicator system utilized within a vehicle, according to an embodiment of the present invention; and

FIG. 6 is a flowchart illustrating one embodiment of a methodology for implementing the traffic flow system, according to an embodiment of the present invention.

### DETAILED DESCRIPTION

In the following description, numerous details are set forth to provide an understanding of the present invention. However, it will be understood by those of ordinary skill in the art that the present invention may be practiced without these details and that numerous variations or modifications from the described embodiments may be possible.

The present invention relates to a system and methodology for reducing traffic congestion, improving traffic flow, and saving fuel during motor vehicle use. Simple indicators are provided to a driver of a vehicle in an unobtrusive form to help the driver determine whether the immediately preceding vehicle is moving away from the driver's vehicle, e.g. positively accelerating relative to the driver's vehicle, or moving toward the driver's vehicle, e.g. negatively accelerating (decelerating) relative to the driver's vehicle. In one embodiment, the indicators comprise lights that are located within a vehicle such that they are noticeable in the peripheral vision of the driver without intruding on the driver's observance of the road. The present system and methodology are designed to provide the indicators with respect to the vehicle immediately ahead of and in the same lane as the vehicle of the operator. In some embodiments, the system functions with respect to the preceding vehicle only when that vehicle is within a relatively small forward region, such as between 3 and 60 feet in distance ahead of the vehicle of the operator.

The system also is designed to be relatively inexpensive to enable retrofitting of existing cars and addition as original equipment without substantially adding to the cost of the vehicle. The greater the number of vehicles on a given highway utilizing the present system and technology, the greater the potential for avoiding standing wave traffic patterns and for facilitating the smooth flow of traffic.

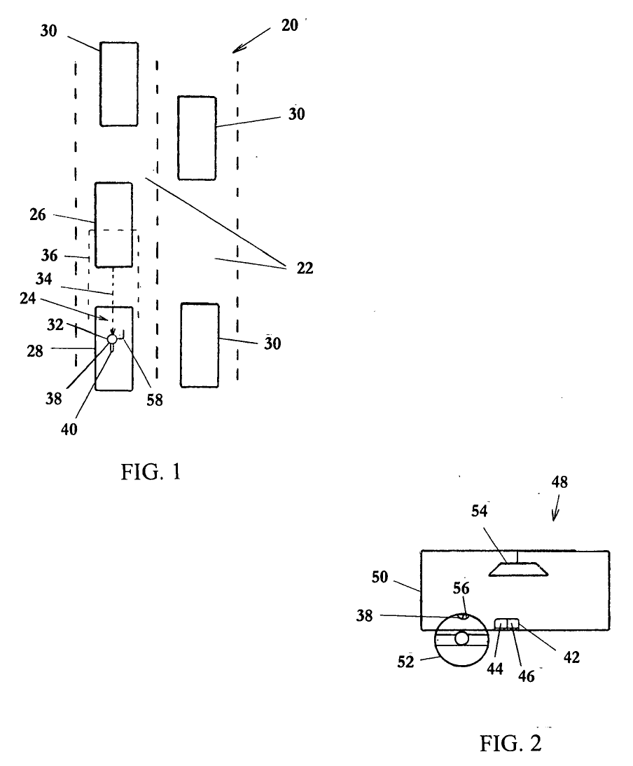

Referring generally to FIG. 1, an embodiment of the present invention is illustrated. A highway system 20 is illustrated as having a plurality of lanes 22. For the purpose of explanation, a traffic flow facilitator system 24 is illustrated and described with respect to a lead or preceding vehicle 26 and a following vehicle 28 moving along within the same lane 22. Other vehicles 30, which may or may not contain traffic flow system 24, also are illustrated as moving along one of the highway lanes 22. In this embodiment, vehicle 28 comprises a sensor system 32 able to sense relative speed differentials between vehicle 28 and vehicle 26. In other words, sensor system 32 is designed to sense and determine whether the lead vehicle 26 is moving closer to or farther away from the following vehicle 28, which can result from, for example, a negative or positive acceleration of the vehicle 26 relative to vehicle 28.

The sensor system 32 is designed to detect and measure an energy signal 34 received from the lead vehicle 26. By detecting and processing data from the energy signal, a determination can be made as to whether the speed of the lead vehicle 26 relative to vehicle 28 is positive or negative. Depending on the specific embodiment, the energy signal 34 can be initiated at lead vehicle 26, or it can be initiated in following vehicle 28 and reflected from vehicle 26. By way of example, the energy signal 34 may comprise a microwave signal, such as that used in a Doppler radar system, a Bluetooth™ signal, an FM signal, a radio frequency identification (RFID) signal, an infrared signal, a laser light signal or other appropriate electromagnetic energy signals. In some applications, the energy signal 34 is designed to be useful within a limited region or envelope 36 to avoid interference with vehicles in other lanes or vehicles farther ahead or behind the subject vehicle 28. In one example, the region 36 is limited to an envelope that extends forward less than approximately 60 feet in distance and that covers a lateral range narrower than the highway lane 22. However, other sized regions 36 can be implemented.

The energy signal 34 is received by an appropriate sensor 38 of sensor system 32, and the data is processed by an appropriate processor 40, such as a programmable microprocessor, to determine whether the distance between vehicle 26 and vehicle 28 is increasing or decreasing, e.g. whether the relative speed is positive or negative. If an increase or decrease is determined, this information is provided to the driver of vehicle 28 through a simple indicator mechanism 42 located in the peripheral vision of the driver, as illustrated in FIG. 2. A variety of visual, audio or other simple indicators can be provided to the driver in a manner that does not interfere with the driver's cognitive abilities or observation of the road. By way of example, indicator mechanism 42 may comprise a first indicator 44 and a second indicator 46 to provide the driver with an indication that vehicle 26 is closing the gap to vehicle 28 or moving away from vehicle 28. In one embodiment, first indicator 44 and second indicator 46 comprise lights that illuminate to provide the driver with a simple visual event for guiding the driver in determining whether to speed up or slow down more rapidly. The first and second indicators may be lights of different colors or lights with different illuminated symbols.

FIG. 2 provides one example of a potential layout for an interior cabin 48 of vehicle 28. In this embodiment, indicator mechanism 42 may be positioned out of the operator's direct line of sight so as not to interfere with the driver's view through a windshield 50 of the vehicle. For example, indicator mechanism 42 may be mounted on a steering wheel 52 or on a dash area below a rear view mirror 54. In this embodiment, sensor 38 may be mounted on steering wheel 52 to receive energy signal 34 through windshield 50. However, sensor 38 can be mounted in other areas within the interior of the cabin or external to the vehicle cabin. Similarly, processor 40 can be mounted on steering wheel 52 or in other regions of the vehicle. In some embodiments, processor 40 and the processing capability can be integrated with the standard vehicle electronic control unit. However, in other embodiments, it is desirable to maintain the traffic flow system 24 as a modular system that can be disconnected and moved from one vehicle to another.

Depending on the specific application, sensor system 32 also may comprise a reflected energy transmitter 56 used to output energy signal 34 which is reflected back from the immediately preceding vehicle to sensor 38. As illustrated, reflected energy transmitter 56 also can be mounted to steering wheel 52. Alternatively, the energy transmitter 56 can be mounted to the vehicle in a variety of other locations.

One embodiment utilizing reflected energy transmitter 56 is a radar system that includes an antenna 58 (see FIG. 1) able to output energy signal 34 over the limited region 36. By way of example, the energy signal may be transmitted with a pattern limited to a range of 6 inches to 60 feet in distance and a range of 2 inches to 12 inches in diameter. If an object, e.g. vehicle 26, in a radar beam is moving, the frequency of reflected waves differs from that of the transmitted waves. When vehicle 26 moves away from antenna 58, the reflected energy signal has return waves with a lower frequency. If the velocity of the vehicle 26 is less than that of vehicle 28, the reflected energy signal has return waves with a higher frequency. If vehicle 26 is traveling at the same speed as vehicle 28, the frequency remains unchanged. This phenomenon is known as the Doppler effect and the frequency change is known as a Doppler shift.

As long as vehicle 26 is moving away from vehicle 28, first indicator 44 is active. For example, if first indicator 44 comprises a light, such as a green LED, the indicator is illuminated to make the operator of vehicle 28 aware that the lead vehicle 26 is increasing the distance therebetween. This indicator is visible in the driver's peripheral vision and tells the driver it is safe to increase acceleration. When the Doppler effect shows that the distance is decreasing between vehicle 28 and lead vehicle 26, second indicator 46 becomes active. For example, if second indicator 46 comprises a light, such as a red LED, the second indicator is illuminated to make the operator of vehicle 28 aware that the distance between it and the lead vehicle 26 is decreasing. Indicator mechanism 42 also may comprise a mechanism for indicating a match in speed between vehicles 26 and 28 where neither acceleration nor breaking is required by the driver, allowing for the occurrence of fuel-saving coasting. For example, indicators 44 and/or 46 can be illuminated with a different color, e.g. illuminated with a yellow LED, or an additional indicator can be incorporated into indicator mechanism 42.

In the radar/Doppler system described, the strength of a radar return signal or echo is inversely proportional to the fourth power of the distance of the target from the antenna 58, assuming targets of the same reflected area. Accordingly, a target, e.g. an automobile, positioned half the distance from the antenna as another target of the same character (size, mass, reflectivity) returns a signal 16 times stronger than the more distant target. In this embodiment of system 24, the system can be configured to “see” only the closest target vehicle, i.e. the vehicle directly ahead of vehicle 28, by sensing only the strongest echo. Even if the target vehicle ahead is a small car with a reflectivity and thus a signal strength of only 10% that of a truck positioned ahead of the small car, the Doppler radar system is able to recognize the stronger signal from the true target vehicle directly ahead due to its proximity. This is especially true in heavy, slow traffic where traffic flow system 24 is of particular benefit. The illustrated system also does not require additional expensive circuitry to subtract the speed of the driver's vehicle from closing speeds of other vehicles, because actual speeds of the other vehicles are not relevant to providing a simple indication of differential speeds between the driver's vehicle and the immediately preceding vehicle traveling in the same lane 22.

In this particular embodiment, system 24 can be designed to block or ignore energy signals received from objects in certain situations. For example, signals received from vehicles moving through curves in adjacent lanes can be ignored. Additionally, signals from vehicles in oncoming lanes as well as vehicles or other objects, e.g. road signs, along the side of the road can be ignored. Blocking circuitry can be used to place limitations on the angle of the transmitted and received signals, as known to those of ordinary skill in the art. The use of blocking circuitry may depend on the actual type of energy signal 34 employed in system 24. Some examples of energy signals that produce very narrow and compact waveforms include microwave signals, single or multiple band FM signals, light emitting diodes, laser signals, lidar signals and certain other forms of energy signals.

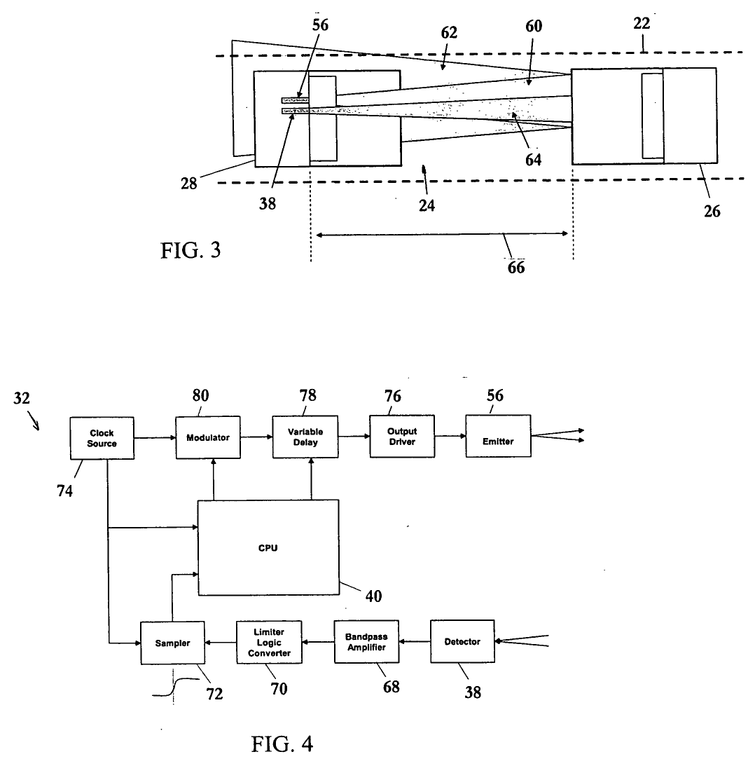

In another specific embodiment, reflected energy transmitter 56 comprises an infrared LED or laser diode, and sensor 38 comprises an infrared or laser energy signal detector, as illustrated in FIG. 3. The reflected energy transmitter 56 is positioned to output in a forward direction an infrared or laser energy signal 34 having a relatively narrow beam width 60. The signal 34 is reflected off the vehicle 26 positioned immediately ahead of vehicle 28 and in the same highway lane 22. The reflected energy has a reflected beam width 62 of sufficient diameter to be detected by sensor 38. In fact, sensor 38 may be designed to have a relatively narrow sensor field of view 64 to avoid false readings from other vehicles. The energy signal 34 travels a given distance 66 between energy transmitter 56 and the rear reflective surface of the vehicle 26 which is the same distance the reflected portion of signal 34 travels back to sensor 38.

In FIG. 4, an embodiment of sensor system 32 utilizing an energy emitter or transmitter 56 is illustrated as a functional block diagram. In this example, the energy output by energy transmitter 56, e.g. a laser or LED emitter, as well as the detection and analysis of the reflected signal by detector/sensor 38 is controlled by processor unit 40. By way of specific example, sensor 38 is coupled to a bandpass amplifier 68 which, in turn, is coupled to a limited logic converter 70. Limited logic converter 70 is coupled to a sampler 72 which is coupled with processor 40 and a clock source 74. The energy emitter 56 is coupled to an output driver 76 that is coupled to a variable delay 78. Variable delay 78 also is coupled directly to processor 40. A modulator 80 is coupled with variable delay 78, processor 40 and clock source 74. Clocks source 74 also is operatively coupled with processor 40.

The processor 40 utilizes software that performs a phase locked loop function and controls variable delay 78 to maintain any incoming wavefront edge centered within a sample window. The amount of delay represents distance 66 to the next vehicle, e.g. vehicle 26. In this embodiment, the functional concept depends on measuring any change in the round-trip propagation time from energy transmitter 56 forward to vehicle 26 and then back to sensor/detector 38. Detecting a change as coarse as 1 foot is adequate to provide appropriate indications to a vehicle driver. In this example, sensor system 32 should be able to detect a difference of about 1 ns in the round-trip propagation travel time for the energy signal 34.

Referring again to FIG. 4, clocks source 74 is used through variable delay 78 to create an emitter output waveform and also to control the sampling of the return reflection waveform. Software within processor 40 adjusts the variable delay so that the round-trip time of the wavefront to the vehicle and back plus the delay results in the detected waveform being sampled right at a waveform edge. The sampler 72 concurrently captures a number of samples at the clock edge. Also, the physical layout of the circuit is arranged to result in a small delay between each sample so the sequence of samples represents the value of the waveform before and after the waveform edge in small equidistant time intervals.

Accordingly, as the distance between vehicles 26 and 28 closes, the waveform edge shifts from the center sample to earlier samples (closer to detector/sensor 38), and the software adjusts the delay to bring the edge back to the center of the sample window group. When this occurs, the programmed processor 40 is able to realize the distance between vehicles is decreasing and to output an appropriate control signal to indicator mechanism 42. As the distance between vehicles increases, the opposite occurs and the software on processor 40 reduces the delay to keep the waveform edge in the center of the sample window. When this occurs, processor 40 is able to realize the distance between vehicles is increasing and to output an appropriate control signal to indicator mechanism 42. Specifically, appropriate software filters the result to avoid flashing of indicators 44, 46 and then appropriately illuminates the proper indicator 44 or 46. Of course, in other embodiments, indicators 44 and 46 may be designed to provide other types of visual, audio or other simple indicators to facilitate improved driver response.

In the example illustrated, variable delay 78 is designed with a very fine resolution, e.g. less than 100 ps, of control by processor 40. The windows sampler 72 also has very fine time steps between each adjacent sample, e.g. less than 100 ps per step. The signal emitter and sensor/detector must be designed to have adequate signal strength for reliable loop operation. In one example, transmitter 56 comprises a laser diode emitter, but other forms of energy can also be used, such as Doppler microwave radar, infrared, radio frequency identification, ultrasound, and other energy forms. Furthermore, appropriate waveform modulation and encoding allow the software on processor 40 to ignore noise from other objects and to determine how many waveform pulses are in “flight” between the energy transmitter 56 and the detector 38 for approximate distance measurement. By way of example, in many applications, a maximum length polynomial generator code of eight bits or more clocked by the system clock is adequate.

In an alternate embodiment, traffic flow system 24 can be incorporated into a larger number of vehicles such that the system can be used to send information on relative velocity between sequential vehicles to vehicles that are farther back. In this embodiment, a communications chain is formed using each vehicle to receive the information from the car in front of it and to send it back to the next sequential vehicle. The system component in each vehicle can use a filtering algorithm, such as a matched filter approach, to combine its own measured information with information passed back from the forward vehicle. This combined data can be transmitted back to the next sequential vehicle. This approach allows a tailored warning time and acts like a “feed-forward” filter network. The use of combined data from multiple sequential vehicles can facilitate improved network stabilization, i.e. improved traffic flow.

To implement this alternate approach, the warning information must arrive earlier than the response time of the driver to increase overall stability of the traffic flow system. The stability is increased by allowing a controlled limited response to this situation instead of the usual over braking and over accelerating that occurs in congested traffic. By way of example, the data transfer function from vehicle to vehicle can be achieved by the analysis of a discrete time model of a transmission line with interleaved gain blocks to achieve stable control loop operation. This can be implemented by constructing energy transmitter 56 with a second emitter and by enabling detector 38 through the use of orthogonal PN codes to modulate the two emitters. The software on processor 40 can then receive the overlapping code pair of its own emitter reflected along with the received signal from the emitter in the vehicle ahead. The processor 40 is readily programmed to mathematically demodulate the two signals into their own data patterns.

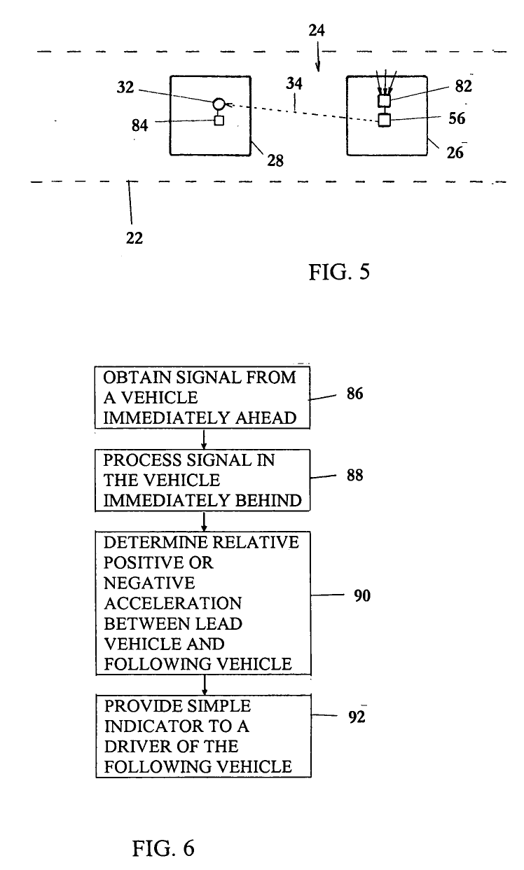

In another embodiment, the energy signal 34 is not reflected from the forward vehicle but is emitted from the forward vehicle for receipt by detector 38 in the following vehicle 28. Referring generally to FIG. 5, this embodiment of traffic flow control system 24 locates energy emitter 56 in the lead vehicle 26. Generally, energy transmitter 56 is designed to emit a directional signal over a short distance toward the vehicle immediately following. By way of example, energy transmitter 56 may be designed to emit RFID signals or Bluetooth™ wireless signals. In one specific example, transmitter 56 outputs RFID signals at 433 MHz or 2.45 GHz for receipt by sensor/detector 38. The system 24 further comprises a global positioning system (GPS) unit 82 operatively coupled with transmitter system 56 via an appropriate processor 40 to enable transmitter 56 to output GPS data related to the geographical location of lead vehicle 26 on a continuous basis.

The GPS data output by transmitter 56 is received by sensor system 32 of the following vehicle 28. The sensor system 32 of vehicle 28 is operatively coupled with a GPS unit 84 which obtains GPS data related to the geographical location of vehicle 28 on a continuous basis. With the aid of processor 40, sensor system 32 is able to continuously compare the location of lead vehicle 26 with its own geographical location and to determine any changes in position between the vehicles resulting from an increase or decrease in the distance between the vehicles. If such changes in relative position are detected, sensor system 32 outputs the appropriate control signal to indicator mechanism 42, as described above. This type of GPS based system also enables a given vehicle, such as vehicle 28, to track changes in the positions of numerous vehicles around vehicle 28. Thus, the GPS based system can readily be used to provide the driver of the vehicle with simple inputs related to the immediately preceding vehicle or other vehicles that would aid the driver in facilitating an improved traffic flow pattern. The GPS based embodiment of system 24 also can be programmed to ignore RFID signals or other transmitted signals from specific vehicles, such as vehicles moving in opposite directions or vehicles located behind vehicle 28.

By incorporating vehicle flow control system 24 into numerous vehicles, the traffic flow patterns of those vehicles along a given highway can be improved dramatically. The flow control system 24 can be incorporated into new vehicles as original equipment or can be retrofitted into existing vehicles. In fact, the components of system 24 can be constructed in a modular form enabling transfer of the system from one vehicle to another.

In operation, each vehicle on a given highway obtains an appropriate energy signal from a vehicle immediately ahead, as illustrated by block 86 of FIG. 6. The signal can either be an originally emitted signal or a reflected signal. Once received, the sensor system of the following vehicle processes the signal, as illustrated by block 88. The processed signal is used to determine changes in the distance between the vehicles which can result from relative positive or negative acceleration between the lead vehicle and the following vehicle, as illustrated by block 90. The determination can be made with a variety of hardware and software components constructed in a variety of configurations depending on, for example, system design parameters and the type of energy signal used to transmit data. Once an increasing or decreasing distance between the vehicles is determined, the system provides a simple indicator to the driver of the following vehicle, as illustrated by block 92. The simple indicator is designed and positioned in such a manner so as not to obstruct the view of the driver and so as not to require any substantial cognitive input.

The flow control system 24 enhances a driver's ability to analyze movement of vehicles in a manner that facilitates a smoother flow of traffic, particularly in congested traffic situations. As greater numbers of vehicles implement the flow control system 24 the traffic flow patterns continue to improve. A variety of components, software and procedures can be used to implement this approach of providing simple indicators to operators of vehicles that improve their responses in congested traffic. For example, the system can integrate feedback from multiple cars with respect to their GPS location and instruct a slow lead car with no vehicle ahead of it to change lanes to the right to improve overall traffic speed in a given line. The improved responses facilitate the smooth flow of traffic by avoiding or reducing standing wave patterns, for example. In some embodiments, flow control system 24 is designed to be active only when the vehicle is traveling at a relatively slow speed, e.g. below 40 mph, which is typical in heavy traffic flow patterns.

Accordingly, although only a few embodiments of the present invention have been described in detail above, those of ordinary skill in the art will readily appreciate that many modifications are possible without materially departing from the teachings of this invention. Such modifications are intended to be included within the scope of this invention as defined in the claims.

What is claimed is:

1. A method of facilitating traffic flow, comprising:
sensing within a first vehicle the relative velocity of a second vehicle positioned ahead of the first vehicle in the same lane of traffic; and
providing a simple indicator to a driver of the first vehicle as to whether the second vehicle has a relative positive velocity or a relative negative velocity with respect to the first vehicle.

2. The method as recited in claim 1, wherein providing comprises indicating the relative positive velocity via a first light of a first color and indicating the relative negative velocity via a second light of a second color.

3. The method as recited in claim 1, wherein sensing comprises sensing the relative velocity of the second vehicle only when the second vehicle is immediately in front of the first vehicle and within approximately 60 feet of the first vehicle.

4. The method as recited in claim 1, further comprising utilizing a reflected energy transmitter positioned on the first vehicle to output a signal that is reflected off the second vehicle, wherein sensing comprises sensing the signal reflected back from the second vehicle.

5. The method as recited in claim 1, wherein sensing comprises sensing a radiofrequency identification (RFID) signal from the second vehicle.

6. The method as recited in claim 5, wherein sensing comprises obtaining global positioning system (GPS) data on the position of the second vehicle.

7. The method as recited in claim 1, wherein sensing comprises sensing a Bluetooth™ signal.

8. The method as recited in claim 1, further comprising analyzing velocity data on at least one vehicle traveling ahead of the second vehicle to send information rearward between sequential vehicles to improve overall traffic flow.

9. The method as recited in claim 4, wherein utilizing comprises outputting a light signal.

10. The method as recited in claim 1, wherein sensing comprises measuring a Doppler effect of a signal reflected from the second vehicle.

11. The method as recited in claim 1, wherein sensing comprises sensing an infrared signal.

12. A system for facilitating traffic flow, comprising:
a sensor for use in a first vehicle to sense changing distances between the first vehicle and a second vehicle only when the second vehicle is immediately in front of the first vehicle; and
a display having a first indicator exhibited when the relative distance between the first vehicle and the second vehicle is increasing and a second indicator exhibited when the relative distance between the first vehicle and the second vehicle is decreasing.

13. The system as recited in claim 12, further comprising a third indicator exhibited when the relative distance between the first and second vehicle is not changing, wherein the first indicator comprises a first light, the second indicator comprises a second light and the third indicator comprises a third light.

14. The system as recited in claim 13, wherein the first light, the second light and the third light have different colors.

15. The system as recited in claim 12, wherein the display is mounted in front of and within view of the driver of the first vehicle.

16. The system as recited in claim 12, wherein the sensor and the display are modular and movable to another vehicle.

17. The system as recited in claim 12, further comprising a processor to process GPS coordinates of the second vehicle received by the sensor.

18. The system as recited in claim 12, further comprising a reflected energy transmitter to transmit a signal against the second vehicle such that the signal is reflected back to the sensor.

19. The system as recited in claim 12, further comprising a processor to integrate GPS coordinates of multiple cars to instruct a slow lead vehicle in a given line to change lanes to improve overall traffic speed for other vehicles in that lane.

20. A method, comprising:
preparing a sensor to sense a specific energy signal only from a vehicle positioned immediately ahead of the sensor in the same lane of a highway; and
operatively coupling the sensor with a display that indicates a positive relative velocity, a negative relative velocity, or equal velocity of the sensor and the vehicle.
